(19) United States
(12) Patent Application Publication
(10) Pub. No.: US 2018/0240292 A1
(43) Pub. Date: Aug. 23, 2018

(54) LOCKING SYSTEM

(71) Applicant: ARDI TECHNOLOGY CORPORATION, New Taipei City (TW)

(72) Inventor: Chih Nong Chen, New Taipei City (TW)

(21) Appl. No.: 15/861,690

(22) Filed: Jan. 4, 2018

(30) Foreign Application Priority Data
Feb. 21, 2017 (TW) 106202501

(51) Int. Cl. G07C 9/00; E05B 47/00; E05B 17/10; H04W 4/80

(52) U.S. Cl. CPC G07C 9/00309; E05B 47/0002; E05B 17/10; G07C 2009/00769; E05B 2047/0085; E05B 2047/0095; H04W 4/80

(57) ABSTRACT

The locking system includes a locking device for installing on a door, which includes a lock member and a bolt member mechanically coupled together. There are a controller, a first Bluetooth module, an electromagnetic valve, and a receiver inside the lock member. The electromagnetic valve mechanically couples the lock member. The controller is electrically connected to the first Bluetooth module, the electromagnetic valve, and the receiver. The locking system further includes a button and an indicator member, both configured on the lock member and electrically connected to the controller. The locking system also includes a mobile device including a second Bluetooth module and a control module. Based on whether the first and second Bluetooth modules are signally linked or not in a proximity or a Keep away condition, the locking system achieves enhanced security and convenience.

### BACKGROUND OF THE INVENTION

### (a) Technical Field of the Invention

The present invention is generally related to locks, and more particular to a locking system whose locking device may wirelessly communicate with a mobile device.

### (b) Description of the Prior Art

Locks are common devices for securing a private environment (e.g., household) against unauthorized intrusions.

Locks have evolved from mechanical locks to electrical ones such as Electric Dropbolt and Cathode Locks using electromagnetism for turning on/off the locks.

Currently, there are more and more locks relying on electronic means and the most popular ones are those based Radio Frequency Identification (RFID) or fingerprint identification techniques. The conventional mechanical locks are susceptible to external impact. Electrical and electronic locks are complex and more costly. RFID-based locks also suffer problems such as keys being unauthorized scanned and copied, etc.

### SUMMARY OF THE INVENTION

To obviate the above shortcomings, a novel locking system is disclosed. The locking system includes a locking device for installing on a door, which includes a lock member and a bolt member mechanically coupled together. There are a controller, a first Bluetooth module, an electromagnetic valve, and a receiver inside the lock member. The electromagnetic valve mechanically couples the lock member, and the controller is electrically connected to the first Bluetooth module, the electromagnetic valve, and the receiver. The locking system further includes a button configured on the lock member and electrically connected to the controller, an indicator member configured on the lock member and electrically connected to the controller, a power module configured inside the locking device and electrically connected to the controller, and a mobile device including a second Bluetooth module, a control module, and a positioning module. The second Bluetooth module is capable of signally linking with the first Bluetooth module. When the first and second Bluetooth modules are signally linked in a proximity condition, operating the button causes the controller to engage the electromagnetic valve, which in turn drives the lock member and the bolt member to retract or extend a bolt of the bolt member and therefore unlock or lock the door. When the first and second Bluetooth modules are not signally linked in a Keep away condition, operating the button does not cause the controller to engage the electromagnetic valve.

The indicator member may include a number of lighting elements capable of emitting different colored lights, respectively. The locking system may further include a remote control device signally linked with the receiver.

The mobile device is one of a smart phone, a tablet computer, a notebook or laptop computer, and a Personal Digital Assistant (PDA). The remote control device may be a Bluetooth remote control device.

The locking system relies on whether the first and second Bluetooth modules are in a proximity or a Keep away condition, together with an electronic fence set on an electronic map by the control module's APP, the arrangement of the directional antenna, the detected Received Signal Strength Indication (RSSI) value, and the software program of the controller, to activate or de-activate the button accordingly so as to achieve enhanced security and convenience.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a locking system according to an embodiment of the present invention.

FIG. 2 is another functional block diagram showing the locking system of FIG. 1.

FIG. 2A is a functional block diagram showing a control module and its electronic map of the locking system of FIG. 1.

FIG. 2B is a schematic diagram showing an electronic fence shown on a mobile device of the locking system of FIG. 1.

FIG. 3 is an application scenario that the locking system of FIG. 1 is installed on a door and unlocked.

FIG. 4 is an application scenario that the locking system of FIG. 1 is installed on a door and locked.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

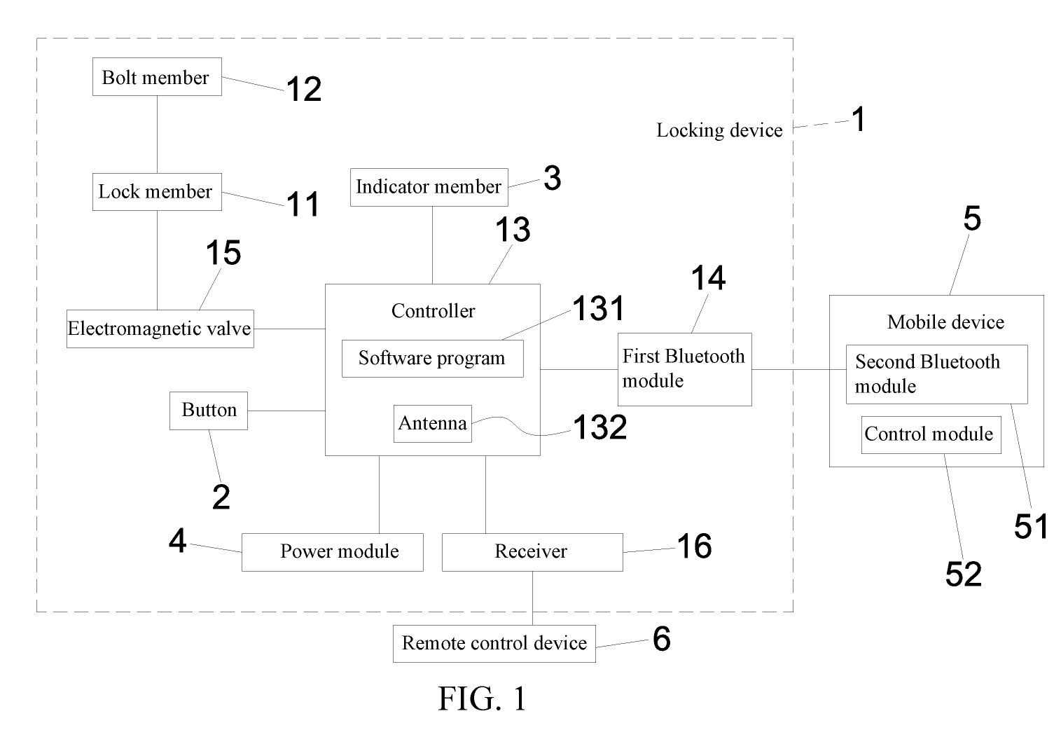

As shown in FIG. 1, a locking system according to an embodiment of the present invention includes a locking device 1, a button 2, an indicator member 3, a power module 4, and a mobile device 5.

The locking device 1 includes a lock member 11 and a bolt member 12. The lock member 11 mechanically couples the bolt member 12. Inside the lock member 11, there are a controller 13, a first Bluetooth module 14, an electromagnetic valve 15, and a receiver 16. The electromagnetic valve 15 mechanically couples the lock member 11. The controller 13 is electrically connected to the first Bluetooth module 14, the electromagnetic valve 15, and the receiver 16. In on embodiment, the electromagnetic valve 15, the lock member 11, and the bolt member 12 are those commonly seen in conventional electric or electronic locking devices, but they are not limited as such. The locking system may further include a remote control device 6 signally connects with the receiver 16.

The button 2 is configured and exposed on the lock member 11. The button 2 is electrically connected to the controller 13, which is electrically connected to the indicator member 3 that is also configured and exposed on the lock member 11. The power module 4 is configured inside the locking device 1 and electrically connected to the controller 13. In the present embodiment, the controller 13 includes a software program 131 and a directional antenna 132. The software program 131 is rewritable and the power module 4 is a DC battery module. However they are not limited as such.

The mobile device 5 may be a smart phone, a tablet computer, a notebook or laptop computer, or a Personal Digital Assistant (PDA). The mobile device 5 includes a second Bluetooth module 51 and a control module 52. The second Bluetooth module 51 signally links with the first Bluetooth module 14. The control module 52 includes a combination of hardware and software where an APP may be executed.

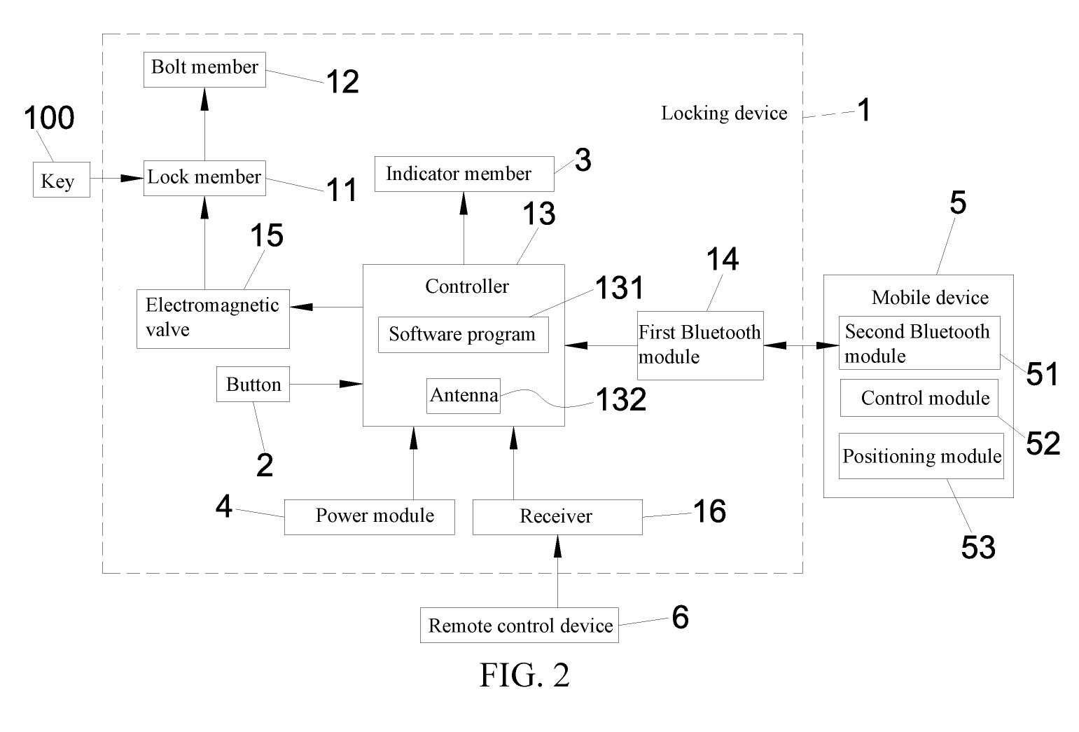

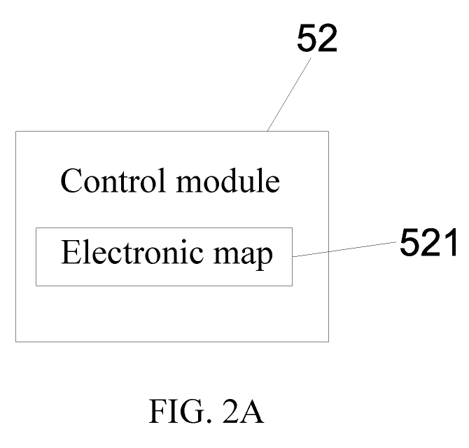

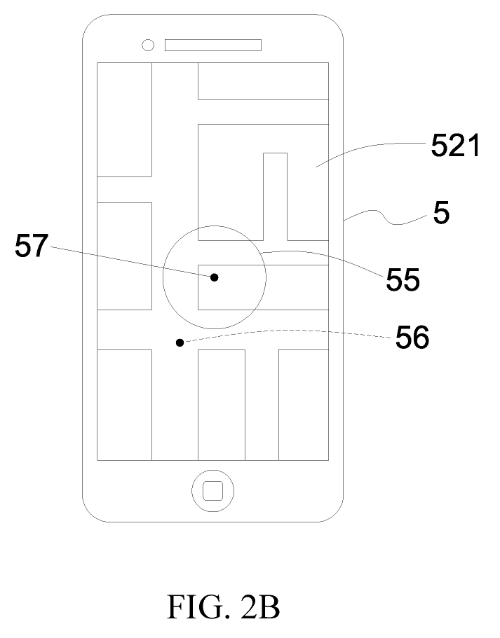

As shown in FIGS. 2, 3, and 4, the locking device 1 is installed on a door 200. In the present embodiment, an engagement element 10 is configured on a first major side of the locking device 1, and the lock member 11 is configured on a second major side of the locking device 1, opposite to the engagement element 10. A bolt 121 of the bolt member 12 is slidably configured on the door 200's rim. The power module 4 provides the required electricity for locking and unlocking the locking device 1. The lock member 11 is usually located on an indoor side of the door 200 whereas the engagement element 10 is located on an outdoor side of the door 200. However, they are not limited as such.

The locking device 1 may be locked or unlocked by applying a key 100 through a keyhole 111 of the lock member 11, and mechanically engaging the bolt member 12 so that the bolt 121 is protruded or retracted. This mechanism is well known to people of the art, and its details are omitted. A user of the mobile device 5, such as the house owner or the site administrator, may pair the mobile device 5 with the first Bluetooth module 14 by the second Bluetooth module 51 of the mobile device 5, through operating the control module 52's user interface. In the present embodiment, the software program 131 is capable of deriving Received Signal Strength Indication (RSSI) through the antenna 132 and the signal strength between the mobile device 5 and the antenna 132 measured by RSSI is used as one of the conditions for security control. As shown in FIGS. 2A and 2B, the control module 52 may set up an electronic fence 55 on an electronic map 521 (e.g., Google Map) which specifies an enclosed area on the map 521 covering the area secured by the door 200. On the other hand, the mobile device 5 includes a built-in positioning module 53 such as a Global Positioning System (GPS). The position detected by the positioning module 53 and the electronic fence 55 jointly provide a second condition for security control.

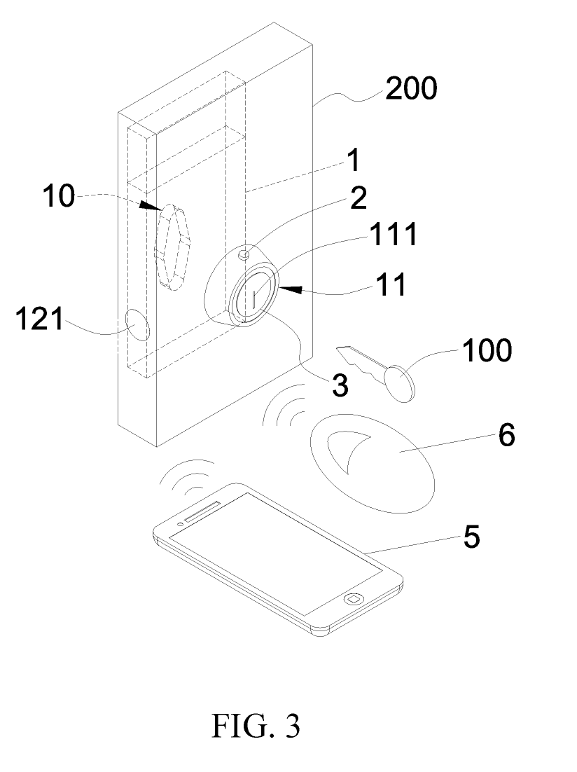

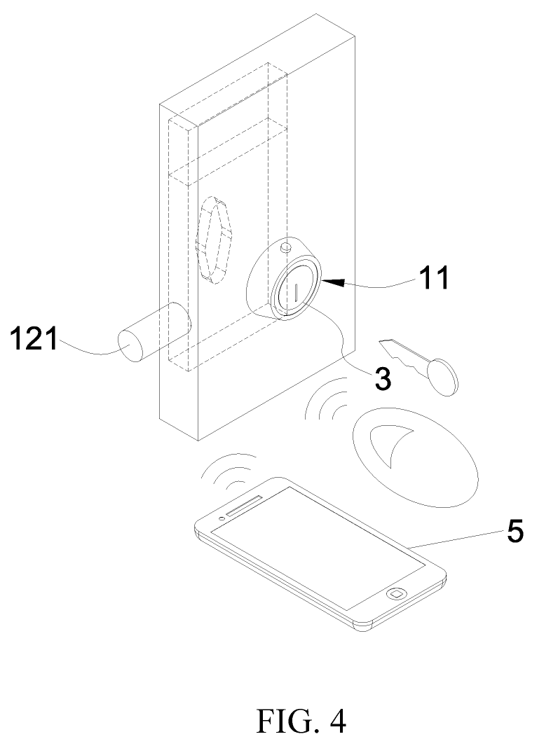

In one scenario when the house owner or the site administrator wants to enter the secured area through the door 200 and as he/she approaches the locking device 1 in the door 200, the second Bluetooth module 51 of the mobile device 5 and the first Bluetooth module 14 of the locking device 1 are in a proximity condition and automatically connected. Since the antenna 132 has a radiation field pattern that is projected towards outside the door, the RSSI signal strength received by the antenna 132 would be of a high value greater than a threshold set by the software program 131. In the meantime, for example, the house owner or the site administrator is at a first position 56 on the electronic map 521 which is outside the electronic fence 55. In other words, only when the mobile device 5 is close to the door 200 from outside the electronic fence 55 with a RSSI value greater than the threshold, the door 200 may be opened by operating the button 2, or by operating the user interface of the control module 52. The button 2 is electrically connected to the controller 13, which is electrically connected to the electromagnetic valve 15. When the button 2 is pressed and the electromagnetic valve 15 is engaged, the lock member 11 and the bolt member 12 are mechanically linked, and the bolt 121 is retracted to open the door 200. In this scenario, the door 200 is originally locked and pressing button 2 therefore unlocks the door 200 (as shown in FIG. 3). In a similar scenario where the house owner or the site administrator exits the door 200 from the secured area and the door 200 is originally unblocked, operating the button 2 or by operating the user interface of the control module 52 may extend the bolt 121 to lock the door 200 (as shown in FIG. 4).

In this scenario, the house owner or the site administrator only has to carry the mobile device 5 (for example, in the pocket), he/she may open the door 200 by just pressing the button 2 which is very convenient, especially when he/she wears gloves and cannot operate the mobile device 5.

In another scenario, the house owner or the site administrator is inside the secured area and the mobile device 5, for example, is at a second position 57 on the electronic map 521 within the electronic fence 55. Since the antenna 132's radiation field pattern is projected towards outside the door, the RSSI signal strength received by the antenna 132 would be of a low value lower than the threshold set by the software program 131. The second Bluetooth module 51 and the first Bluetooth module 14 are in a proximity condition and automatically connected. However, since the mobile device 5 is within the electronic fence 55 with a low RSSI value, the button 2 cannot be operated to open the door 200. If there is a visitor requesting to enter the secured area, the house owner or the site administrator may use the mobile device 5's control module 52 to open the door 200 Similarly, after the visitor enters the secured area, the mobile device 5 may be applied to close the door 200. In other words, by having both the electronic fence 55 and the detection of RSSI value, security and convenience are simultaneously achieved by the present invention.

The indicator member 3 may include a number of lighting elements capable of emitting green, red, yellow, or blue lights, respectively. For example, the indicator member 3 may emit a green light when the bolt 121 is retracted, to indicate that the door 200 is opened. Or, the indicator member 3 may emit a red light when the bolt 121 is extended, indicating that the door 200 is closed. As such, it is more convenient for the house owner or the site administrator to identify the locking or unlocking status of the door 200.

Additionally, the remote control device 6 may be one based on Bluetooth communications, however it is not limited as such. The remote control device 6 may be used to conduct locking or unlocking through the receiver 16. After locking or unlocking, the status may be delivered to the mobile device 5 by the first Bluetooth module 14 through the controller 13 and the control module 52.

Please note that, whether the house owner or the site administrator is within the secured area or not, as long as the second Bluetooth module 51 of the mobile device 5 and the first Bluetooth module 14 of the locking device 1 are in a Keep away condition, the button 2 is not electrically connected to the button 2. Then, the pressing of the button 2 does not electrically connect the controller 13 and the electromagnetic valve 15. In other words, when the second Bluetooth module 51 and the first Bluetooth module 14 are in the Keep away condition, no one, not even the house owner or the site administrator, can operate the button 2 to open the door 200.

As described above, and as shown in FIG. 2, the present invention relies on the communications between the second Bluetooth module 51 of the mobile device 5 and the first Bluetooth module 14 of the locking device 1 to determine whether they are in a proximity condition or are a Keep away condition, together with the electronic fence 55 set on the electronic map 521 by the control module 52's APP, the arrangement of the directional antenna 132, and the software program 131 of the controller 13, to activate or de-activate the button 2 accordingly so as to achieve enhanced security and convenience of the locking system of the present invention.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A locking system, comprising
a locking device for installing on a door, comprising a lock member and a bolt member mechanically coupled together, where there are a controller, a first Bluetooth module, an electromagnetic valve, and a receiver inside the lock member, the electromagnetic valve mechanically couples the lock member, the controller is electrically connected to the first Bluetooth module, the electromagnetic valve, and the receiver;
a button configured and exposed on the lock member, and electrically connected to the controller;
an indicator member configured and exposed on the lock member, and electrically connected to the controller;
a power module configured inside the locking device and electrically connected to the controller, and
a mobile device comprising a second Bluetooth module, a control module, and a positioning module, where the second Bluetooth module is capable of signally linking with the first Bluetooth module;
wherein, when the first and second Bluetooth modules are signally linked in a proximity condition, operating the button causes the controller to engage the electromagnetic valve, which in turn drives the lock member and the bolt member to retract or extend a bolt of the bolt member and therefore unlock or lock the door; and, when the first and second Bluetooth modules are not signally linked in a Keep away condition, operating the button does not cause the controller to engage the electromagnetic valve.

2. The locking system according to claim 1, wherein the indicator member comprises a plurality of lighting elements capable of emitting different colored lights, respectively.

3. The locking system according to claim 1, further comprising a remote control device signally linked with the receiver.

4. The locking system according to claim 3, wherein the remote control device is a Bluetooth remote control device.

5. The locking system according to claim 1, wherein the mobile device is one of a smart phone, a tablet computer, a notebook or laptop computer, and a Personal Digital Assistant (PDA).
